(19) United States
(12) Patent Application Publication
(10) Pub. No.: US 2020/0400946 A1
(43) Pub. Date: Dec. 24, 2020

(54) Methods and Apparatuses for Providing a Waveguide Display with Angularly Varying Optical Power

(71) Applicant: DigiLens Inc., Sunnyvale, CA (US)

(72) Inventors: Jonathan David Waldern, Los Altos Hills, CA (US); Alastair John Grant, San Jose, CA (US); Milan Momcilo Popovich, Leicester (GB)

(73) Assignee: DigiLens Inc., Sunnyvale, CA (US)

(21) Appl. No.: 16/911,253

(22) Filed: Jun. 24, 2020

Related U.S. Application Data
(60) Provisional application No. 62/865,885, filed on Jun. 24, 2019.

(51) Int. Cl. G02B 27/01; F21V 8/00; G03H 1/02

(52) U.S. Cl. CPC G02B 27/0103; G02B 6/0035; G03H 1/0244; G03H 2260/33; G02B 2027/011; G02B 2027/0118; G03H 2260/12; G03H 1/0248

(57) ABSTRACT

Systems and methods for waveguide displays with angularly varying optical power in accordance with various embodiments of the invention are illustrated. One embodiment includes a waveguide display including a source of image modulated light projected over a field of view, and a waveguide including at least one output grating with an optical prescription providing angularly varying optical power for focusing the field of view onto an external surface. In another embodiment, the at least one output grating includes at least one grating prescription providing a first focal length for focusing a first FOV portion onto a first area of the surface and a second focal length for focusing a second FOV portion onto a second area of the surface. In still another embodiment, the at least one output grating includes at least one grating prescription providing a continuously varying focal length across at least a portion of the FOV.

### CROSS-REFERENCE TO RELATED APPLICATIONS

The current application claims the benefit of and priority under 35 U.S.C. § 119(e) to U.S. Provisional Patent Application No. 62/865,885 entitled “Methods and Apparatuses for Providing a Waveguide Display with Angularly Varying Optical Power,” filed Jun. 24, 2019. The disclosure of U.S. Provisional Patent Application No. 62/865,885 is hereby incorporated by reference in its entirety for all purposes.

### FIELD OF THE INVENTION

The present invention generally relates to waveguide displays and, more specifically, to waveguide displays for projecting imagery with angularly varying optical power.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE INVENTION

Systems and methods for waveguide displays with angularly varying optical power in accordance with various embodiments of the invention are illustrated. One embodiment includes a waveguide display including a source of image modulated light projected over a field of view, and a waveguide including at least one output grating with an optical prescription providing angularly varying optical power for focusing the field of view onto an external surface.

In another embodiment, the at least one output grating includes at least one grating prescription providing at least two different focal lengths across the FOV.

In a further embodiment, the at least one output grating includes at least one grating prescription providing a first focal length for focusing a first FOV portion onto a first area of the surface and a second focal length for focusing a second FOV portion onto a second area of the surface.

In still another embodiment, the at least one output grating includes at least one grating prescription providing a continuously varying focal length across at least a portion of the FOV.

In a still further embodiment, the external surface subtends an angle of less than 45 degrees to a viewing axis of the display.

In yet another embodiment, the external surface subtends and angle of less than 15 degrees to viewing axis of the display.

In a yet further embodiment, the waveguide display further includes a reflective or transmissive optical-powered element disposed along an optical path from the waveguide and a viewer of the waveguide display.

In another additional embodiment, the source of image modulated light provides first image data for projection at a first range and second image data for projection at a second range.

In a further additional embodiment, the first and second image data are digitally magnified to provide projected image dimensions on the external surface scaled to the first and second ranges.

In another embodiment again, the at least one output grating includes at least one grating prescription providing a first focal length for focusing a first FOV portion onto a first area of the surface located at less than 3 meters from the waveguide and a second focal length for focusing a second FOV portion onto a second area of the surface located at greater than 3 meters from the waveguide.

In a further embodiment again, the at least one output grating includes at least one grating switchable between a diffracting state and a non-diffracting state.

In still yet another embodiment, the external surface includes a surface selected from the group consisting of a virtual image surface, a real image surface, a curved surface, a reflective surface, and an at least partially transmissive surface.

In a still yet further embodiment, the source of image modulated light includes an optical engine selected from the group consisting of a scanned laser projector, a projector including an emissive display and a collimator, a projector including a microdisplay illuminated by one of laser or LED and a collimator, and a structured light projector.

In still another additional embodiment, the waveguide provides a projector in a windscreen reflection head up display, wherein the at least one output grating includes at least one grating prescription for correcting distortions introduced by reflection at the windscreen.

In a still further additional embodiment, the at least one output grating includes at least one grating prescription for correction of a characteristic selected from the group consisting of distortion introduced by an optical element disposed between waveguide and a viewer, polarization non-uniformity, and illumination non-uniformity.

In still another embodiment again, the at least one output grating includes at least one grating prescription for diffracting radiation in the infrared band.

In a still further embodiment again, imaging by the waveguide operates according to the Scheimpflug principle.

In yet another additional embodiment, the waveguide further includes at least one of a LIDAR, an eye tracker, a lens with electrically variable optical power, or a despeckler.

A yet further additional embodiment includes a method of viewing an image, including the steps of providing a source of image modulated light projected over a field of view, providing a waveguide including at least one output grating with an optical prescription for focusing the field of view onto an external surface, tilting the output optical axis of the waveguide at an acute angle to the surface, focusing a first FOV portion onto a first area of the surface, and focusing a second FOV portion onto a second area of the surface.

Yet another embodiment again includes a method of viewing an image, including the steps of providing a source of image modulated light projected over a field of view, providing a waveguide supporting a switchable output grating with a prescription providing at least two different focal lengths across the FOV, providing a waveguide supporting a switchable output grating with a prescription providing continuously varying focal length across at least a portion of the FOV, tilting the output optical axis of the waveguide at an acute angle to the surface, switching the first grating into a diffracting state and switching the second grating into a non-diffracting state, focusing a first FOV portion onto a first area of the surface, focusing a second FOV portion onto a second area of the surface, switching the first grating into a non-diffracting state and switching the second grating into a diffracting state, and providing a continuously varying focal length across at least a portion of the FOV.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a waveguide display with two different focal points in accordance with an embodiment of the invention.

FIG. 2 conceptually illustrates a waveguide display with a series of focal points in accordance with an embodiment of the invention.

FIG. 3 conceptually illustrates a waveguide display with an external surface disposed in proximity to a surface in the external environment in accordance with an embodiment of the invention.

FIG. 4 conceptually illustrates a waveguide display with an external transmissive optical-powered element in accordance with an embodiment of the invention.

FIG. 5 conceptually illustrates a waveguide display with an external partially reflecting surface in accordance with an embodiment of the invention.

FIG. 6 conceptually illustrates a waveguide display for road transportation applications in accordance with an embodiment of the invention.

FIG. 7 conceptually illustrates a color waveguide in accordance with an embodiment of the invention.

FIG. 8 conceptually illustrates the formation of images in a road transportation application in accordance with an embodiment of the invention.

FIG. 9 is a chart showing a typical characteristic of a projected image focal range in meters with the display vertical coordinate in accordance with an embodiment of the invention.

FIG. 10 conceptually illustrates the formation of images in a road transportation application in accordance with an embodiment of the invention.

FIGS. 11 and 12 are flow diagrams conceptually illustrating methods of displaying an image in accordance with various embodiments of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating that includes of a set of gratings in some embodiments. For illustrative purposes, it is to be understood that the drawings are not drawn to scale unless stated otherwise.

Waveguide displays with angularly varying optical power can be utilized in many different applications for various purposes. By implementing angularly varying optical power, the waveguide display can be configured to display different images having different focal lengths. This can be advantageous in many different applications. For example, the waveguide display can be implemented in a vehicle to provide a driver with information that is overlaid with the road. With images displayed at different focal lengths, virtual objects can be provided at different distances across the road and the surrounding environment. In many embodiments, the waveguide display includes at least one input coupler and an output grating for focusing a field-of-view onto an external surface. In some embodiments, an output grating has a grating prescription providing a first focal length for focusing a first FOV portion onto a first area of the external surface and a second focal length for focusing a second FOV portion onto a second area of the external surface. The viewer's eye can be positioned inside the eyebox of the display. In various embodiments, the first and second areas are at different ranges, or distances, from the eyebox. In several embodiments, the output grating includes at least one grating prescription providing a first focal length for focusing a first FOV portion onto a first area of the surface located at less than 3 meters from the waveguide and a second focal length for focusing a second FOV portion onto a second area of the surface located at greater than 3 meters from the waveguide. The techniques for designing and encoding optical functions into a grating are well known to those skilled in the design of Holographic Optical Elements (HOEs) and Diffractive Optical Elements (DOEs). Any method of encoding optical functions into gratings can be utilized. In many embodiments, an output grating in accordance with various embodiments of the invention can be fabricated by first designing and fabricating a Computer-Generated Hologram (CGH) with the required optical properties and then recording the CGH into the grating. Any method for recording the CGH into the SBG can be utilized. For example, various holographic recording techniques known to those skilled in the art of holography may be used. In a number of embodiments, the output grating is fabricated using an inkjet printing process, which can be used in combination with traditional holography. Inkjet printing processes for recording gratings are described in further detail in U.S. patent application Ser. No. 16/203,071 filed Nov. 28, 2018 entitled “Systems and Methods for Manufacturing Waveguide Cells.” The disclosure of U.S. patent application Ser. No. 16/203,071 is hereby incorporated by reference in its entirety for all purposes. In many embodiments, the waveguide gratings are recorded in a liquid crystal and polymer material system. In some embodiments, the gratings include at least one grating recorded in a holographic photopolymer. In several embodiments, the gratings include at least one surface relief grating.

In embodiments in which the waveguide provides a projector in a windscreen reflection head up display, the output grating can have an optical prescription for correcting distortions introduced by reflection at the windscreen. In many embodiments, the waveguide grating can have a prescription for correcting at least one selected from the group of distortion introduced by an optical element disposed between the waveguide and the eyebox, polarization non-uniformity, and illumination non-uniformity. In some embodiments, the output grating can include at least one grating prescription for diffracting different wavelengths. In several embodiments, image formation by the waveguide operates according to the Scheimpflug principle. In many embodiments, the waveguide can include at least one selected from the group of an input grating, a prismatic input coupler, a fold grating, a beamsplitter, a polarization control layer, a gradient index medium, an external cladding layer, and an alignment layer. In some embodiments, the display system can further include at least one selected from the group of a LIDAR, an eye tracker, a lens with electrically variable optical power, and a despeckler. Grating architectures, material systems, and waveguide displays implementing angularly varying optical power are discussed in the sections below in further detail.

### Optical Waveguide and Grating Structures

Optical structures recorded in waveguides can include many different types of optical elements, such as but not limited to diffraction gratings. Gratings can be implemented to perform various optical functions, including but not limited to coupling light, directing light, and preventing the transmission of light. In many embodiments, the gratings are surface relief gratings that reside on the outer surface of the waveguide. In other embodiments, the grating implemented is a Bragg grating (also referred to as a volume grating), which are structures having a periodic refractive index modulation. Bragg gratings can be fabricated using a variety of different methods. One process includes interferential exposure of holographic photopolymer materials to form periodic structures. Bragg gratings can have high efficiency with little light being diffracted into higher orders. The relative amount of light in the diffracted and zero order can be varied by controlling the refractive index modulation of the grating, a property that can be used to make lossy waveguide gratings for extracting light over a large pupil.

One class of Bragg gratings used in holographic waveguide devices is the Switchable Bragg Grating (SBG). SBGs can be fabricated by first placing a thin film of a mixture of photopolymerizable monomers and liquid crystal material between substrates. The substrates can be made of various types of materials, such glass and plastics. In many cases, the substrates are in a parallel configuration. In other embodiments, the substrates form a wedge shape. One or both substrates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize, and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (ITO). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 μs with a longer relaxation time to switch ON. The diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The substrates used to form the HPDLC cell provide a total internal reflection (TIR) light guiding structure. Light can be coupled out of the SBG when the switchable grating diffracts the light at an angle beyond the TIR condition.

In some embodiments, LC can be extracted or evacuated from the SBG to provide an evacuated Bragg grating (EBG). EBGs can be characterized as a surface relief grating (SRG) that has properties very similar to a Bragg grating due to the depth of the SRG structure (which is much greater than that practically achievable using surface etching and other conventional processes commonly used to fabricate SRGs). The LC can be extracted using a variety of different methods, including but not limited to flushing with isopropyl alcohol and solvents. In many embodiments, one of the transparent substrates of the SBG is removed, and the LC is extracted. In further embodiments, the removed substrate is replaced. The SRG can be at least partially backfilled with a material of higher or lower refractive index. Such gratings offer scope for tailoring the efficiency, angular/spectral response, polarization, and other properties to suit various waveguide applications.

Waveguides in accordance with various embodiments of the invention can include various grating configurations designed for specific purposes and functions. In many embodiments, the waveguide is designed to implement a grating configuration capable of preserving eyebox size while reducing lens size by effectively expanding the exit pupil of a collimating optical system. The exit pupil can be defined as a virtual aperture where only the light rays which pass though this virtual aperture can enter the eyes of a user. In some embodiments, the waveguide includes an input grating optically coupled to a light source, a fold grating for providing a first direction beam expansion, and an output grating for providing beam expansion in a second direction, which is typically orthogonal to the first direction, and beam extraction towards the eyebox. As can readily be appreciated, the grating configuration implemented waveguide architectures can depend on the specific requirements of a given application. In some embodiments, the grating configuration includes multiple fold gratings. In several embodiments, the grating configuration includes an input grating and a second grating for performing beam expansion and beam extraction simultaneously. The second grating can include gratings of different prescriptions, for propagating different portions of the field-of-view, arranged in separate overlapping grating layers or multiplexed in a single grating layer. Furthermore, various types of gratings and waveguide architectures can also be utilized.

In several embodiments, the gratings within each layer are designed to have different spectral and/or angular responses. For example, in many embodiments, different gratings across different grating layers are overlapped, or multiplexed, to provide an increase in spectral bandwidth. In some embodiments, a full color waveguide is implemented using three grating layers, each designed to operate in a different spectral band (red, green, and blue). In other embodiments, a full color waveguide is implemented using two grating layers, a red-green grating layer and a green-blue grating layer. As can readily be appreciated, such techniques can be implemented similarly for increasing angular bandwidth operation of the waveguide. In addition to the multiplexing of gratings across different grating layers, multiple gratings can be multiplexed within a single grating layer—i.e., multiple gratings can be superimposed within the same volume. In several embodiments, the waveguide includes at least one grating layer having two or more grating prescriptions multiplexed in the same volume. In further embodiments, the waveguide includes two grating layers, each layer having two grating prescriptions multiplexed in the same volume. Multiplexing two or more grating prescriptions within the same volume can be achieved using various fabrication techniques. In a number of embodiments, a multiplexed master grating is utilized with an exposure configuration to form a multiplexed grating. In many embodiments, a multiplexed grating is fabricated by sequentially exposing an optical recording material layer with two or more configurations of exposure light, where each configuration is designed to form a grating prescription. In some embodiments, a multiplexed grating is fabricated by exposing an optical recording material layer by alternating between or among two or more configurations of exposure light, where each configuration is designed to form a grating prescription. As can readily be appreciated, various techniques, including those well known in the art, can be used as appropriate to fabricate multiplexed gratings.

In many embodiments, the waveguide can incorporate at least one of: angle multiplexed gratings, color multiplexed gratings, fold gratings, dual interaction gratings, rolled K-vector gratings, crossed fold gratings, tessellated gratings, chirped gratings, gratings with spatially varying refractive index modulation, gratings having spatially varying grating thickness, gratings having spatially varying average refractive index, gratings with spatially varying refractive index modulation tensors, and gratings having spatially varying average refractive index tensors. In some embodiments, the waveguide can incorporate at least one of: a half wave plate, a quarter wave plate, an anti-reflection coating, a beam splitting layer, an alignment layer, a photochromic back layer for glare reduction, and louvre films for glare reduction. In several embodiments, the waveguide can support gratings providing separate optical paths for different polarizations. In various embodiments, the waveguide can support gratings providing separate optical paths for different spectral bandwidths. In a number of embodiments, the gratings can be HPDLC gratings, switching gratings recorded in HPDLC (such switchable Bragg Gratings), Bragg gratings recorded in holographic photopolymer, or surface relief gratings. In many embodiments, the waveguide operates in a monochrome band. In some embodiments, the waveguide operates in the green band. In several embodiments, waveguide layers operating in different spectral bands such as red, green, and blue (RGB) can be stacked to provide a three-layer waveguiding structure. In further embodiments, the layers are stacked with air gaps between the waveguide layers. In various embodiments, the waveguide layers operate in broader bands such as blue-green and green-red to provide two-waveguide layer solutions. In other embodiments, the gratings are color multiplexed to reduce the number of grating layers. Various types of gratings can be implemented. In some embodiments, at least one grating in each layer is a switchable grating.

Waveguides incorporating optical structures such as those discussed above can be implemented in a variety of different applications, including but not limited to waveguide displays. In various embodiments, the waveguide display is implemented with an eyebox of greater than 10 mm with an eye relief greater than 25 mm. In some embodiments, the waveguide display includes a waveguide with a thickness between 2.0-5.0 mm. In many embodiments, the waveguide display can provide an image field-of-view of at least 50° diagonal. In further embodiments, the waveguide display can provide an image field-of-view of at least 70° diagonal. The waveguide display can employ many different types of picture generation units (PGUs). In several embodiments, the PGU can be a reflective or transmissive spatial light modulator such as a liquid crystal on Silicon (LCoS) panel or a micro electromechanical system (MEMS) panel. In a number of embodiments, the PGU can be an emissive device such as an organic light emitting diode (OLED) panel. In some embodiments, an OLED display can have a luminance greater than 4000 nits and a resolution of 4 k×4 k pixels. In several embodiments, the waveguide can have an optical efficiency greater than 10% such that a greater than 400 nit image luminance can be provided using an OLED display of luminance 4000 nits. Waveguides implementing P-diffracting gratings (i.e., gratings with high efficiency for P-polarized light) typically have a waveguide efficiency of 5%-6.2%. Since P-diffracting or S-diffracting gratings can waste half of the light from an unpolarized source such as an OLED panel, many embodiments are directed towards waveguides capable of providing both S-diffracting and P-diffracting gratings to allow for an increase in the efficiency of the waveguide by up to a factor of two. In some embodiments, the S-diffracting and P-diffracting gratings are implemented in separate overlapping grating layers. Alternatively, a single grating can, under certain conditions, provide high efficiency for both p-polarized and s-polarized light. In several embodiments, the waveguide includes Bragg-like gratings produced by extracting LC from HPDLC gratings, such as those described above, to enable high S and P diffraction efficiency over certain wavelength and angle ranges for suitably chosen values of grating thickness (typically, in the range 2-5 μm).

### Optical Recording Material Systems

HPDLC mixtures generally include LC, monomers, photoinitiator dyes, and coinitiators. The mixture (often referred to as syrup) frequently also includes a surfactant. For the purposes of describing the invention, a surfactant is defined as any chemical agent that lowers the surface tension of the total liquid mixture. The use of surfactants in PDLC mixtures is known and dates back to the earliest investigations of PDLCs. For example, a paper by R. L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. I 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element having: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s. Many of these materials use acrylate monomers, including:
R. L. Sutherland et al., Chem. Mater. 5, 1533 (1993), the disclosure of which is incorporated herein by reference, describes the use of acrylate polymers and surfactants. Specifically, the recipe comprises a crosslinking multifunctional acrylate monomer; a chain extender N-vinyl pyrrolidinone, LC E7, photoinitiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y. H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T. J. Bunning et al., Polymer Science: Part B: Polymer Physics, Vol. 35, 2825-2833, 1997, the disclosure of which is incorporated herein by reference, also describes multifunctional acrylate monomers.
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.
   Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.
   Waveguide Displays with Angularly Varying Optical Power and Related Applications

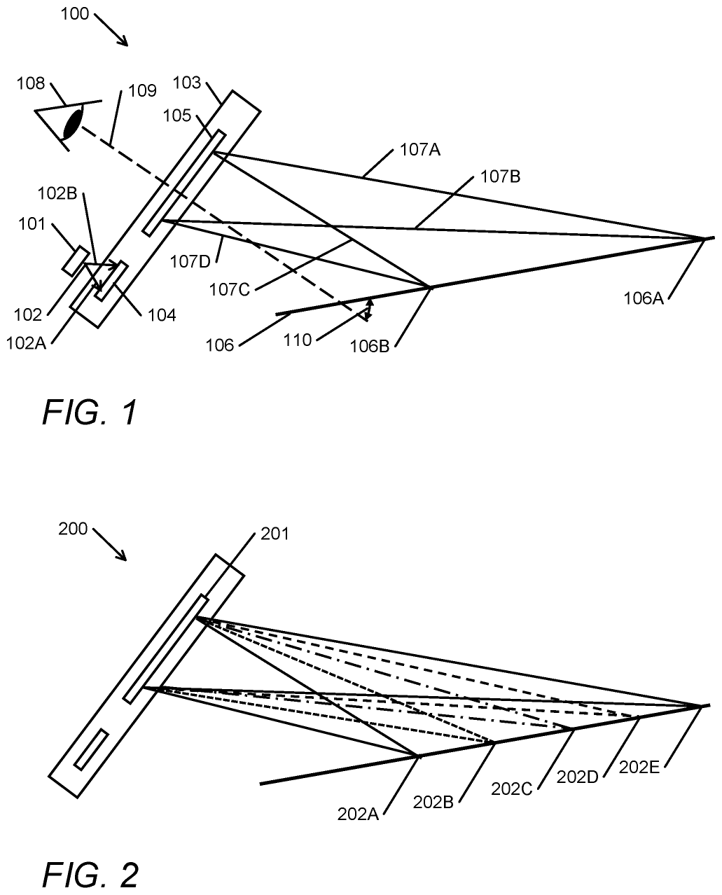

Turning now to the drawings, systems and methods relating to displays and sensors for projecting imagery with angularly varying optical power in accordance with various embodiments of the invention are illustrated. In many embodiments, a transparent waveguide display that can superimpose sharply focused perspective-matched computer-generated image data onto an external scene is implemented. FIG. 1 conceptually illustrates a waveguide display with two different focal points in accordance with an embodiment of the invention. As shown, the waveguide display 100 includes a source of collimated image modulated light 101 projected over a field of view (FOV) 102. The waveguide display 100 further includes a waveguide 103 having an input coupler 104 for directing collimated light 102 of each FOV direction (102A and 1026 for example) into a separate total internal path within the waveguide 103. In the illustrative embodiment, the waveguide 103 further includes at least one output grating 105. In a number of embodiments, the waveguide 103 supports at least one fold grating. To simplify the description, the total internal paths are not illustrated. In the illustrative embodiment, the input coupler 104 is a grating. In other embodiments, the input coupler 104 is a prism.

In the embodiment of FIG. 1, the output grating 105 has an optical prescription providing angularly varying optical power for focusing the field of view onto an external surface 106. Focused output rays 107A, 107B corresponding to one FOV direction are focused to a first point 106A while output rays 107C, 107D corresponding to another FOV direction are focused to a second point 1066. In many embodiments, the external surface 106 is a virtual image surface formed on the side of the waveguide 103 opposite to a viewer 108 of the display. In some embodiments, the points 106A and 106B are disposed along a vertical direction relative to the viewer 108. The external surface 106 can be a real image surface, a curved surface, a reflective surface, or an at least partially transmissive surface. In the illustrative embodiment of FIG. 1, the viewing axis 109, which is a line through the center of the eyebox intersecting the output grating plane at ninety degrees, intersects the external surface 106 at an acute angle 110. As can readily be appreciated, the specific angle at which the line intersects the external surface can depend on the specific requirements of a given application. In many embodiments, the acute angle is less than 45 degrees. In further embodiments, the acute angle is less than 15 degrees.

Although FIG. 1 show the formation of two focal points, more focal points can be provide depending on the optical prescription of the output grating 105. FIG. 2 conceptually illustrates a waveguide display with a series of focal points in accordance with an embodiment of the invention. In the illustrative embodiment, the waveguide display 200 includes at least one output grating 201 having at least one grating prescription that provides a continuously varying focal length, represented by the series of focal points 202A-202E, across at least a portion of the FOV.

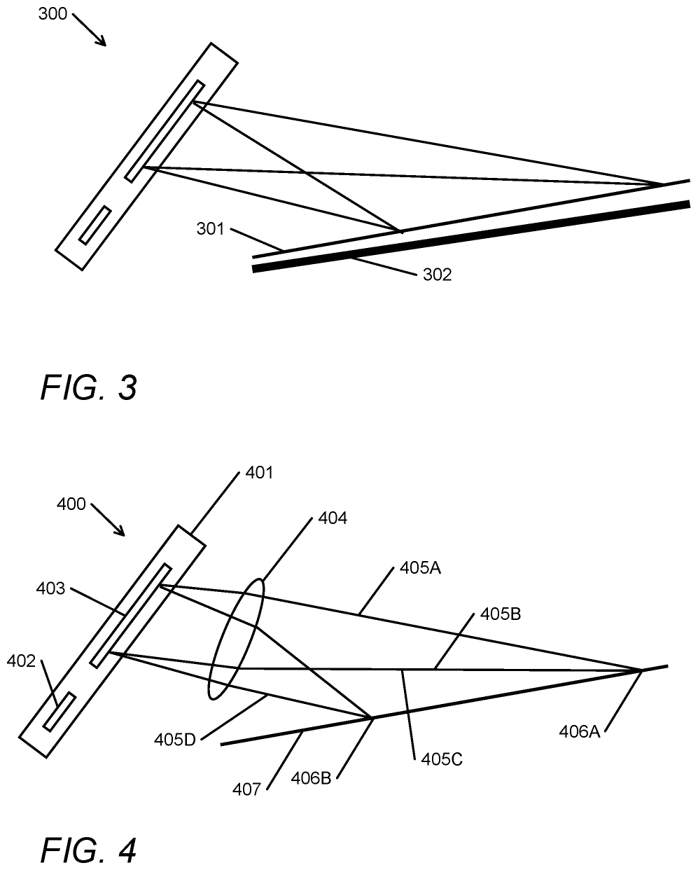

In many embodiments, the external surface is formed in close proximity to a surface in the external environment. In embodiments directed at displays for vehicle applications, the surface in the external environment can be a road surface. In embodiments directed at robot vehicles, the surface in the external environment can be a surface of a vehicle or stationary object in the environment. FIG. 3 conceptually illustrates a waveguide display 300 with an external surface 301 disposed in proximity to a surface 302 in the external environment in accordance with an embodiment of the invention.

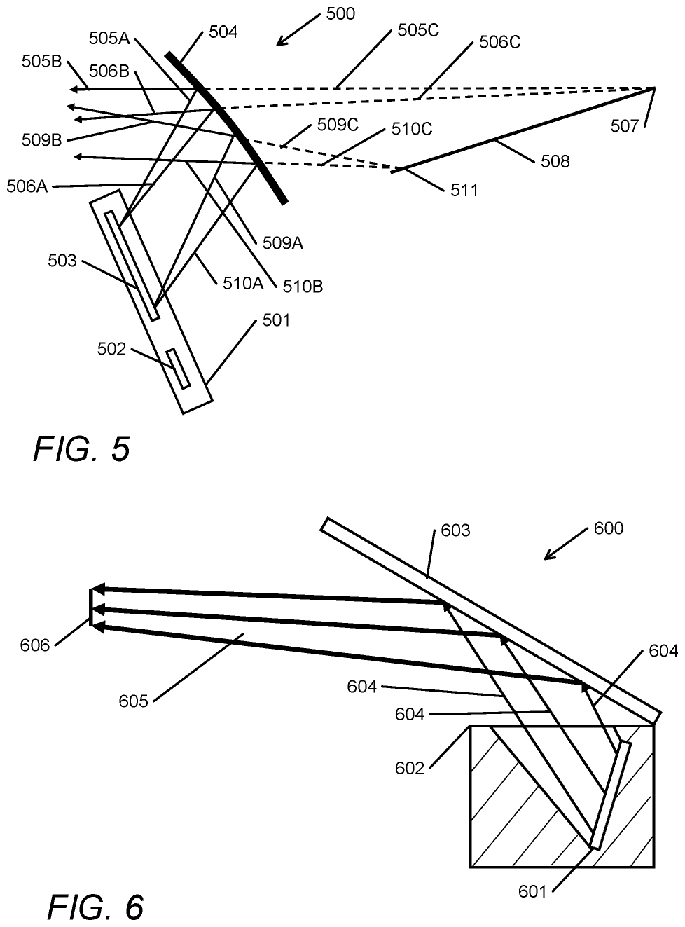

In many embodiments, a waveguide display is implemented to include a reflective or transmissive optical-powered element disposed along an optical path from the waveguide and a viewer of the display. FIG. 4 conceptually illustrates a waveguide display with an external transmissive optical-powered element in accordance with an embodiment of the invention. As shown, the waveguide display 400 includes a waveguide 401 supporting an input coupler 402, an output grating 403, and a lens 404. In the embodiment of FIG. 4, the lens 404 is a transmissive optical-powered element. The combined optical prescriptions of the output grating 403 and the lens 404 can focus output rays 405A, 405B to form a first focal point 406A on an external surface 407. The combined optical prescriptions can also focus output rays 405C, 405D to form a second focal point 406B on the external surface 407. FIG. 5 conceptually illustrates a waveguide display with an external partially reflecting surface in accordance with an embodiment of the invention. As shown, the waveguide display 500 includes a waveguide 501 supporting an input coupler 502, an output grating 503, and a partially reflecting surface 504. In many embodiments, the partially reflecting surface 504 can be curved in at least one dimension. The combined optical prescriptions of the output grating 503 and the partially reflecting surface 504 can focus the output ray bundle containing rays 505A, 506A extracted from the waveguide 501, rays 505B, 506B reflected off of the partially reflecting surface 504, and virtual rays 505C, 506C to form a first focal point 507 on the external surface 508. Similarly, the output ray bundle containing rays 509A, 510A extracted from the waveguide 501, rays 509B, 510B reflected off of the partially reflecting surface 504, and virtual rays 509C, 510C can be focused to form a second focal point 511 on the external surface 508.

Although FIGS. 1-5 illustrate specific waveguide display implementations, many different configurations and grating architectures can be utilized as appropriate depending on the specific requirements of a given application. As can readily be appreciated, the architecture of the waveguides shown in FIGS. 2-5 can be of a similar nature to that of the embodiment shown in FIG. 1. In many embodiments, the waveguide includes at least one input coupler for coupling light into the waveguide, at least one fold grating for redirecting TIR light within the waveguide to a different TIR direction within the waveguide, and at least one output grating for coupling TIR light out of the waveguide. In some embodiments, the waveguide utilizes a prism as the input coupler.

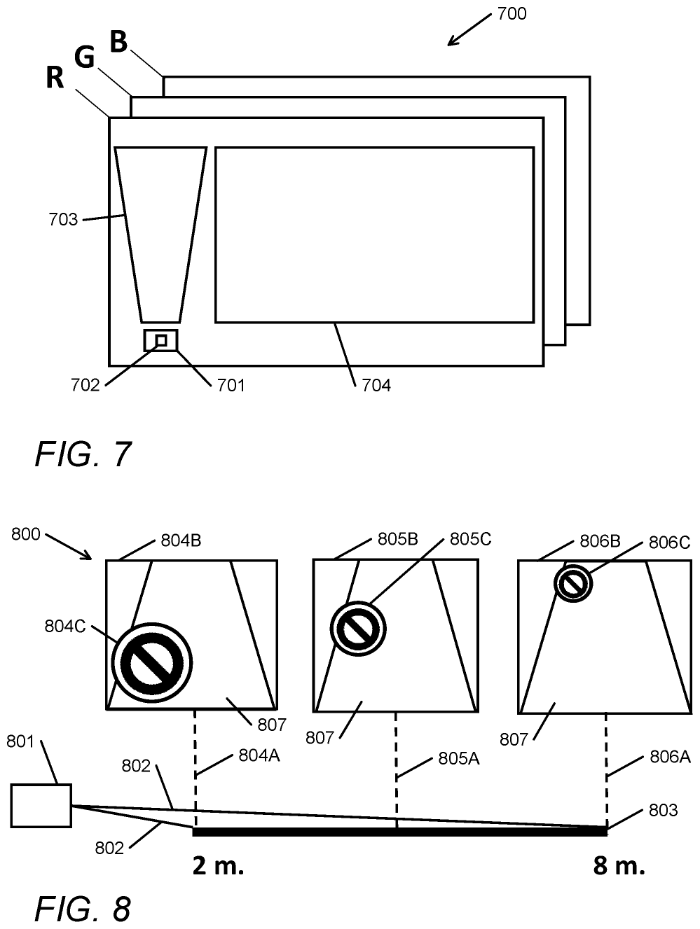

In addition to the use of various waveguide and grating architectures, displays in accordance with various embodiments of the invention can be utilized in a number of different applications. FIG. 6 conceptually illustrates a waveguide display for road transportation applications in accordance with an embodiment of the invention. In the illustrative embodiment, the waveguide display 600 includes a waveguide 601 disposed within a well configured within a dashboard 602, a windshield 603 for reflecting light 604 extracted from the waveguide 601 and along a different beam path 605 towards an eyebox 606. Waveguide 601 can be implemented using a variety of different waveguide configurations, including those based on any of the embodiments discussed herein. In some embodiments, an RGB color waveguide is implemented using a three-layered construction. FIG. 7 conceptually illustrates a color waveguide in accordance with an embodiment of the invention. As shown, the waveguide 700 includes separated red, green, and blue waveguides labeled by symbols R,G,B. In the illustrative embodiment, each waveguide supports an input grating 701 optically coupled to a source 702 of image modulated collimated light, a fold grating 703 for providing beam expansion in a first direction, and an output grating 704 for providing beam expansion in a second direction different from the first direction and beam extraction towards an eyebox. In the embodiment of FIG. 7, the fold and output gratings 703, 704 are configured such that the first and second directions are orthogonal to one another.

In many embodiments, the source of image modulated light projected over a field of view can be provided a scanned laser projector, a projector that includes an emissive display and a collimator, or a projector that includes a microdisplay illuminated by one of laser or LED and a collimator. In some embodiments, the source of image modulated light provides first image data for projection at a first range and second image data for projection at a second range. In several embodiments, the first and second image data are digitally magnified to provide projected image dimensions on the surface scaled to the first and second ranges.

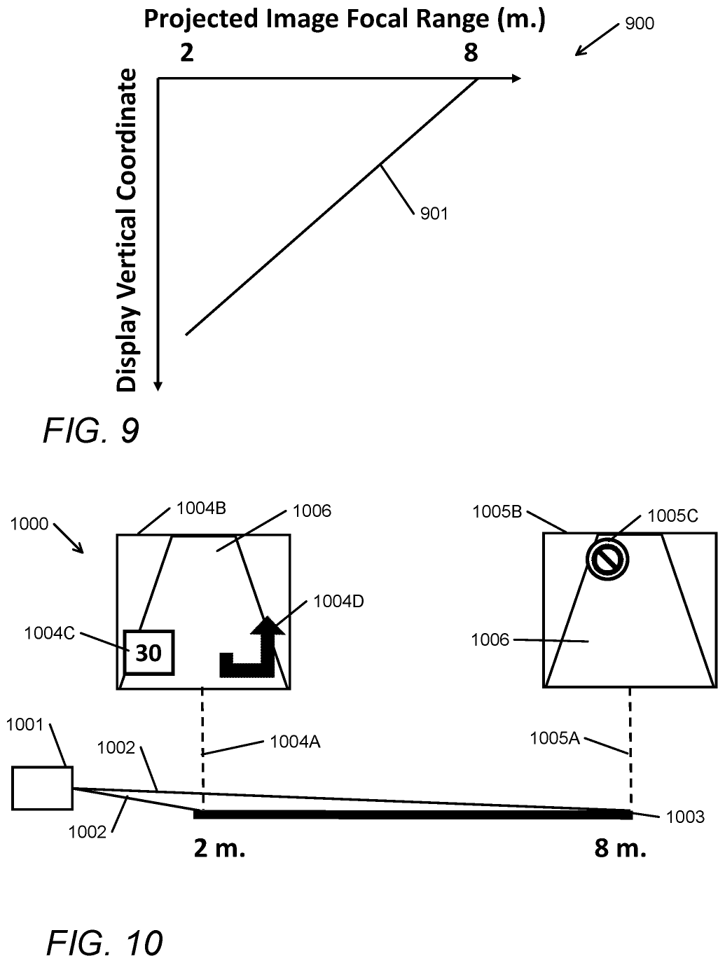

FIG. 8 conceptually illustrates the formation of images in a road transportation application in accordance with an embodiment of the invention. In the illustrative embodiment, the apparatus 800 includes a waveguide display system 801, which can be based on any the embodiments disclosed herein, for projecting output light 802, which is focused onto an external image surface 803 formed in proximity to a road surface. Near and far ranges of 2 meters and 8 meters are shown for illustration purposes. It should be apparent from the drawings and description that such systems can be applied to any near and far ranges. Examples of projected image content corresponding to road ranges indicated by dashed lines 804A-806A are illustrated by the inset frames 804B-806B. Each projected image shows a road sign 804C-806C overlaid over the road 807 viewed through a transparent waveguide. The frame 804B, which contains image data for viewing at the shortest viewing range, provides the largest image of the road sign 804C. The size of the road sign relative to the road 807 diminishes at longer ranges as indicated by frames 805B and 806B. FIG. 9 is a chart 900 showing a typical relationship characteristic 901 of the projected image focal range in meters with the display vertical coordinate (in arbitrary units) in accordance with an embodiment of the invention. Hence, by maintaining sharp focus over the external surface, the dimensions of projected symbolic data can be matched to the required viewing range. In many embodiments, a given symbol can diminish in size in accordance with the viewer's optical perspective as the viewing range increases, thereby allowing a more intuitive augmented reality representation.

Although FIG. 8 illustrate a specific implementation of forming images at different distances for road transportation applications, various configurations can be implemented as appropriate depending on the specific requirements of a given application. For example, in many embodiments, information such as but not limited to current speed and turn directions can be displayed as icons. FIG. 10 conceptually illustrates one such embodiment. In the illustrative embodiment, the apparatus 1000 includes a waveguide display system 1001, which can be based on any the embodiments disclosed herein, for projecting output light 1002, which is focused onto an external image surface 1003 formed in proximity to a road surface. Near and far ranges of 2 meters and 8 meters are shown for illustration purposes. Examples of projected images corresponding to road ranges indicated by dashed lines 1004A, 1005A are illustrated by the inset frames 1004B, 1005B. Each projected image shows at least one symbology overlaid over the road 1006 and background scenery viewed through a transparent waveguide. Frame 1004B, which corresponds to the shortest viewing range, provides instrument symbolic data 1004C, 1004D while frame 1005B, which corresponds to the longest viewing range, provides road sign symbology 1005C.

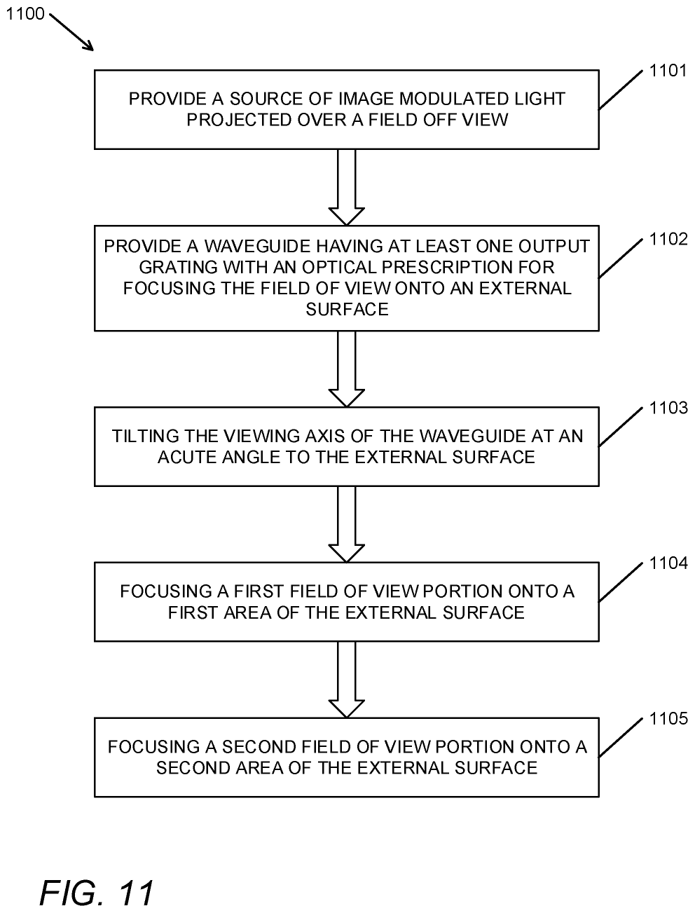

FIG. 11 conceptually illustrates a flow diagram illustrating a method of displaying an image in accordance with an embodiment of the invention. As shown, the method 1100 includes providing (1101) a source of image modulated light projected over a field of view. A waveguide including at least one output grating with an optical prescription for focusing the field of view onto an external surface can be provided (1102). The viewing axis of the waveguide can be tilted (1103) at an acute angle to the external surface. A first FOV portion can be focused (1104) onto a first area of the surface. A second FOV portion can be focused (1105) onto a second area of the surface.

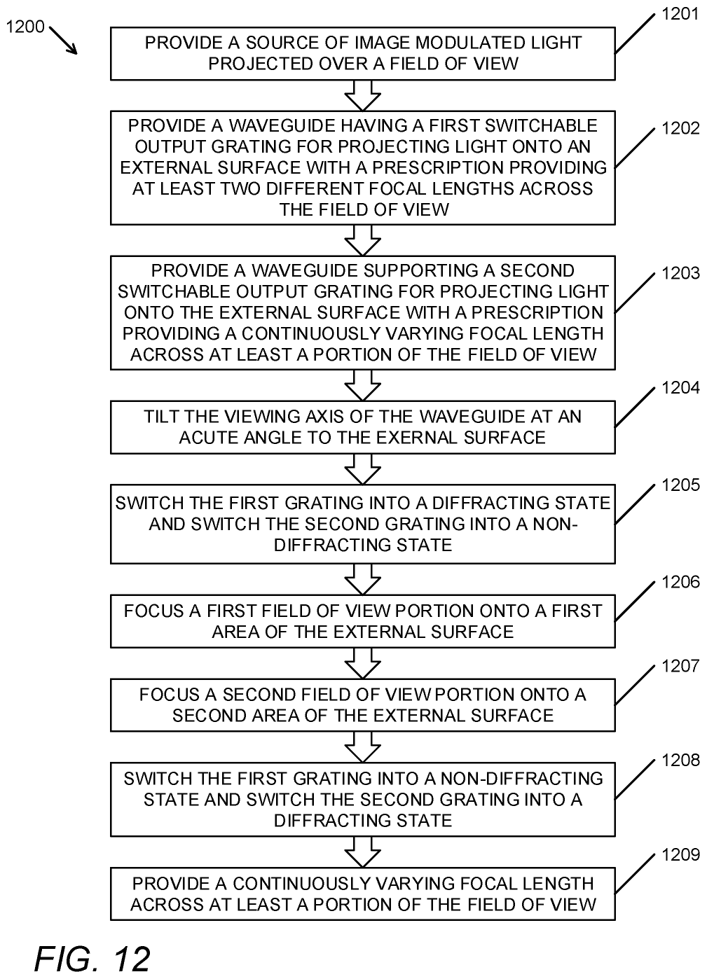

Methods for displaying images can utilize various waveguide display systems. In many embodiments, a waveguide display having at least one output grating that includes at least one grating switchable between a diffracting state and a non-diffracting state. In some embodiments, the output grating can include two overlaid switchable gratings, one grating providing two or more focal lengths for projecting data at at least two different ranges and the other grating providing a continuously varying focal length along the external surface. FIG. 12 conceptually illustrates a flow diagram illustrating a method of displaying an image using switchable Bragg gratings in accordance with an embodiment of the invention. As shown, the method 1200 includes providing (1201) a source of image modulated light projected over a field of view. A waveguide having a first switchable output grating with a prescription providing at least two different focal lengths across the FOV can be provided (1202). A waveguide having a second switchable output grating with a prescription providing a continuously varying focal length across at least a portion of the FOV can be provided (1203). In many embodiments, the first and second switchable output gratings are disposed within a single waveguide. In other embodiments, the first and second switchable output gratings are disposed in separate waveguides. The output gratings can be configured to project light onto an external surface. The viewing axis of the waveguide can be tilted (1204) at an acute angle to the external surface. The first grating and the second grating can be switched (1205) into a diffracting state and a non-diffracting state, respectively. A first FOV portion can be focused (1206) onto a first area of the external surface, and a second FOV portion can be focused (1207) onto a second area of the external surface. The first grating and the second grating can be switched (1208) into a non-diffracting state and a diffracting state, respectively. A continuously varying focal length can be provided (1209) across at least a portion of the FOV. In some embodiments, the states switched in steps 1205 and 1209 are reversed. For example, in a number of embodiments, reverse mode SBGs are utilized.

### OTHER EMBODIMENTS

In many embodiments, the waveguide structures can provide an imaging sensor. In some embodiments, the apparatus can be configured for use with an imaging sensor. In such embodiments, the imaging sensor can take the place of a human eye. In some embodiments, the apparatus can operate in the infrared or in the ultraviolet bands. In several embodiments, the waveguide and the external environment can be in relative motion. In a number of embodiments, the waveguide can be used to project structured light for object tracking or external surface characterization. In many embodiments, the output grating can contain prescriptions for different relative orientations of the external surface to the viewer.

In some embodiments, the apparatus includes at least one grating with spatially varying pitch. In several embodiments, each grating has a fixed K vector. In many embodiments, at least one of the gratings is a rolled k-vector grating according to the embodiments and teachings disclosed in the cited references. Rolling the K-vectors can allow the angular bandwidth of the grating to be expanded without the need to increase the waveguide thickness. In some embodiments, a rolled K-vector grating includes a waveguide portion containing discrete grating elements having differently aligned K-vectors. In some embodiments, a rolled K-vector grating includes a waveguide portion containing a single grating element within which the K-vectors undergo a smooth monotonic variation in direction.

In some embodiments, a prism may be used as an alternative to the input grating. In many embodiments, this can require that an external grating be provided for grating vector closure purposes. In some embodiments, the external grating may be disposed on the surface of the prism. In some embodiments, the external grating may form part of a laser despeckler disposed in the optical train between the laser projector and the input prims. The use of a prism to couple light into a waveguide has the advantage of avoiding the significant light loss and restricted angular bandwidth resulting from the use of a rolled K-vector grating. A practical rolled K-vector input grating typically cannot match the much larger angular bandwidth of the fold grating, which can be 40 degrees or more.

In embodiments directed at displays using unpolarized light sources, the input gratings used in the invention can combine gratings orientated such that each grating diffracts a particular polarization of the incident unpolarized light into a waveguide path. Such embodiments may incorporate some of the embodiments and teachings disclosed in the PCT application PCT/GB2017/000040 “METHOD AND APPARATUS FOR PROVIDING A POLARIZATION SELECTIVE HOLOGRAPHIC WAVEGUIDE DEVICE,” which is incorporated herein in by reference in its entirety. The output gratings can be configured in a similar fashion so the light from the waveguide paths is combined and coupled out of the waveguide as unpolarized light. For example, in some embodiments the input grating and output grating each combine crossed gratings with peak diffraction efficiency for orthogonal polarizations states. In some embodiments, the polarization states are S-polarized and P-polarized. In some embodiments, the polarization states are opposing senses of circular polarization. The advantage of gratings recorded in liquid crystal polymer systems, such as SBGs, in this regard is that owing to their inherent birefringence, they can exhibit strong polarization selectivity. However, other grating technologies that can be configured to provide unique polarization states may be used.

In embodiments using gratings recorded in liquid crystal polymer material systems, at least one polarization control layer overlapping at least one of the fold gratings, input gratings, or output gratings may be provided for the purposes of compensating for polarization rotation in any the gratings, particularly the fold gratings, which may result in polarization rotation. In some embodiments, all of the gratings are overlaid by polarization control layers. In some embodiments, polarization control layers are applied to the fold gratings only or to any other subset of the gratings. The polarization control layer may include an optical retarder film. In some embodiments based on HPDLC materials, the birefringence of the gratings may be used to control the polarization properties of the waveguide device. The use of the birefringence tensor of the HPDLC grating, K-vectors and grating footprints as design variables opens up the design space for optimizing the angular capability and optical efficiency of the waveguide device. In some embodiments, a quarter wave plate disposed on a glass-air interface of the waveguide rotates polarization of a light ray to maintain efficient coupling with the gratings. For example, in one embodiment, the quarter wave plate is a coating that is applied to substrate waveguide. In some waveguide display embodiments, applying a quarter wave coating to a substrate of the waveguide may help light rays retain alignment with the intended viewing axis by compensating for skew waves in the waveguide. In some embodiments, the quarter wave plate may be provided as multi-layer coating.

As used in relation to any of the embodiments described herein, the term grating may encompass a grating that includes of a set of gratings in some embodiments. For example, in some embodiments the input grating and output grating each include two or more gratings multiplexed into a single layer. It is well established in the literature of holography that more than one holographic prescription can be recorded into a single holographic layer. Methods for recording such multiplexed holograms are well known to those skilled in the art. In some embodiments, the input grating and output grating may each include two overlapping gratings layers that are in contact or vertically separated by one or more thin optical substrate. In some embodiments, the grating layers are sandwiched between glass or plastic substrates. In some embodiments two or more such gratings layers may form a stack within which total internal reflection occurs at the outer substrate and air interfaces. In some embodiments, the waveguide may include just one grating layer. In some embodiments, electrodes may be applied to faces of the substrates to switch gratings between diffracting and clear states. The stack may further include additional layers such as beam splitting coatings and environmental protection layers.

In some embodiments, the fold grating angular bandwidth can be enhanced by designing the grating prescription to facilitate dual interaction of the guided light with the grating. Exemplary embodiments of dual interaction fold gratings are disclosed in U.S. patent application Ser. No. 14/620,969 entitled WAVEGUIDE GRATING DEVICE, the disclosure of which is hereby incorporated by reference in its entirety.

Advantageously, to improve color uniformity, gratings for use in the invention are designed using reverse ray tracing from the eye box to the input grating via the output grating and fold grating. This process allows the required physical extent of the gratings, in particular the fold grating, to be identified. Unnecessary grating real-state, which contributes to haze, can be eliminated. Ray paths are optimized for red, green and blue, each of which follow slightly different paths because of dispersion effects between the input and output gratings via the fold grating.

In many embodiments the input grating, fold grating and the output grating are holographic gratings, such as a switchable or non-switchable Bragg Gratings. In some embodiments, the input coupler, the fold grating, and the output grating embodied as SBGs can be Bragg gratings recorded in a holographic polymer dispersed liquid crystal (HPDLC) (e.g., a matrix of liquid crystal droplets), although SBGs may also be recorded in other materials. In one embodiment, SBGs are recorded in a uniform modulation material, such as POLICRYPS or POLIPHEM having a matrix of solid liquid crystals dispersed in a liquid polymer. The SBGs can be switching or non-switching in nature. In some embodiments least one of the input, fold and output gratings may be electrically switchable. In many embodiments, it is desirable that all three grating types are passive, that is, non-switching. In its non-switching form, an SBG has the advantage over conventional holographic photopolymer materials of being capable of providing high refractive index modulation due to its liquid crystal component. Exemplary uniform modulation liquid crystal-polymer material systems are disclosed in United State Patent Application Publication No.: US2007/0019152 by Caputo et al and PCT Application No. PCT/EP2005/006950 by Stumpe et al. both of which are incorporated herein by reference in their entireties. Uniform modulation gratings are characterized by high refractive index modulation (and hence high diffraction efficiency) and low scatter. In some embodiments, the input coupler, the fold grating, and the output grating are recorded in a reverse mode HPDLC material. Reverse mode HPDLC differs from conventional HPDLC in that the grating is passive when no electric field is applied and becomes diffractive in the presence of an electric field. The reverse mode HPDLC may be based on any of the recipes and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES. The gratings may be recorded in any of the above material systems but used in a passive (non-switching) mode. The advantage of recording a passive grating in a liquid crystal polymer material is that the final hologram benefits from the high index modulation afforded by the liquid crystal. Higher index modulation translates to high diffraction efficiency and wide angular bandwidth. The fabrication process is identical to that used for switched but with the electrode coating stage being omitted. LC polymer material systems are highly desirable in view of their high index modulation. In some embodiments, the gratings are recorded in HPDLC but are not switched.

In many embodiments, the source of data modulated light used with the above waveguide embodiments includes an Input Image Node (IIN) incorporating a microdisplay. The input grating is configured to receive collimated light from the IIN and to cause the light to travel within the waveguide via total internal reflection between the first surface and the second surface to the fold grating. Typically, the IIN integrates in addition to the microdisplay panel, a light source and optical components needed to illuminate the display panel, separate the reflected light, and collimate it into the required FOV. Each image pixel on the microdisplay is converted into a unique angular direction within the first waveguide. The invention does not assume any particular microdisplay technology. In some embodiments, the microdisplay panel may be a liquid crystal device or a MEMS device. In some embodiments, the microdisplay may be based on Organic Light Emitting Diode (OLED) technology. Such emissive devices would not require a separate light source and would therefore offer the benefits of a smaller form factor. In some embodiments, the IIN may be based on a scanned modulated laser. The IIN projects the image displayed on the microdisplay panel such that each display pixel is converted into a unique angular direction within the substrate waveguide according to some embodiments. The collimation optics contained in the IIN may include lens and mirrors, which in some embodiments may be diffractive lenses and mirrors. In some embodiments, the IIN may be based on the embodiments and teachings disclosed in U.S. patent application Ser. No. 13/869,866 entitled HOLOGRAPHIC WIDE-ANGLE DISPLAY, and U.S. patent application Ser. No. 13/844,456 entitled TRANSPARENT WAVEGUIDE DISPLAY. In some embodiments, the IIN contains beamsplitter for directing light onto the microdisplay and transmitting the reflected light towards the waveguide. In one embodiment the beamsplitter is a grating recorded in HPDLC and uses the intrinsic polarization selectivity of such gratings to separate the light illuminating the display and the image modulated light reflected off the display. In some embodiments, the beam splitter is a polarizing beam splitter cube. In some embodiment, the IIN incorporates a despeckler. Advantageously, the despeckler is holographic waveguide device based on the embodiments and teachings of U.S. Pat. No. 8,565,560 entitled LASER ILLUMINATION DEVICE. The light source can be a laser or LED and can include one or more lenses for modifying the illumination beam angular characteristics. The image source can be a micro-display or laser-based display. LED will provide better uniformity than laser. If laser illumination is used, there is a risk of illumination banding occurring at the waveguide output. In some embodiments, laser illumination banding in waveguides can be overcome using the techniques and teachings disclosed in U.S. Provisional Patent Application No. 62/071,277 entitled METHOD AND APPARATUS FOR GENERATING INPUT IMAGES FOR HOLOGRAPHIC WAVEGUIDE DISPLAYS. In some embodiments, the light from the light source 101 is polarized. In one or more embodiments, the image source is a liquid crystal display (LCD) micro display or liquid crystal on silicon (LCoS) micro display.

The principles and teachings of the invention in combination with other waveguide as disclosed in the reference documents incorporated by reference herein may be applied in many different display and sensor devices. For example, waveguide structures described in U.S. application patent Ser. No. 13/506,389 entitled “Compact Edge Illuminated Diffractive Display” filed on Apr. 17, 2012 and U.S. patent application Ser. No. 15/863,798 entitled “Wearable Heads Up Displays” filed Jan. 5, 2018 can be implemented in conjunction with various embodiments of the invention. The disclosures of U.S. application Ser. Nos. 13/506,389 and 15/863,798 are hereby incorporated by reference in their entireties for all purposes.

In some embodiments of the invention directed at displays, a waveguide display according to the principles of the invention is combined with an eye tracker. In many embodiments, the eye tracker is a waveguide device overlaying the display waveguide and is based on the embodiments and teachings of PCT/GB2014/000197 entitled HOLOGRAPHIC WAVEGUIDE EYE TRACKER, PCT/GB2015/000274 entitled HOLOGRAPHIC WAVEGUIDE OPTICALTRACKER, and PCT Application No. GB2013/000210 entitled APPARATUS FOR EYE TRACKING.

In some embodiments of the invention directed at displays a waveguide display according to the principles of the invention further include a dynamic focusing element. The dynamic focusing element may be based on the embodiments and teachings of U.S. patent application Ser. No. 15/553,120 entitled “Electrically Focus-Tunable Lens.” In some embodiments, a waveguide display according to the principles of the invention further comprising a dynamic focusing element and an eye tracker may provide a light field display based on the embodiments and teachings disclosed in U.S. patent application Ser. No. 15/543,013 entitled “Light Field Displays Utilizing Holographic Waveguides.”

In some embodiments of the invention directed at displays a waveguide according to the principles of the invention may be based on some of the embodiments of U.S. patent application Ser. No. 13/869,866 entitled HOLOGRAPHIC WIDE-ANGLE DISPLAY, and U.S. patent application Ser. No. 13/844,456 entitled TRANSPARENT WAVEGUIDE DISPLAY. In some embodiments, a waveguide apparatus according to the principles of the invention may be integrated within a window, for example a windscreen-integrated HUD for road vehicle applications. In some embodiments, a window-integrated display may be based on the embodiments and teachings disclosed in United States Provisional Patent Application No.: PCT Application No. PCT/GB2016/000005 entitled ENVIRONMENTALLY ISOLATED WAVEGUIDE DISPLAY. In some embodiments, a waveguide apparatus may include gradient index (GRIN) wave-guiding components for relaying image content between the IIN and the waveguide. Exemplary embodiments are disclosed in PCT Application No. PCT/GB2016/000005 entitled ENVIRONMENTALLY ISOLATED WAVEGUIDE DISPLAY. In some embodiments, the waveguide apparatus may incorporate a light pipe for providing beam expansion in one direction based on the embodiments disclosed in U.S. Provisional Patent Application No. 62/177,494 entitled WAVEGUIDE DEVICE INCORPORATING A LIGHT PIPE.

The embodiments of the invention may be used in wide range of display applications including HMDs for AR and VR, helmet mounted displays, projection displays, heads up displays (HUDs), Heads Down Displays, (HDDs), autostereoscopic displays and other 3D displays. Some of the embodiments and teachings of this disclosure may be applied in waveguide sensors such as, for example, eye trackers, fingerprint scanners, and LIDAR systems.

The construction and arrangement of the systems and methods as shown in the various exemplary embodiments are illustrative only. Although only a few embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A waveguide display comprising:
a source of image modulated light projected over a field of view; and
a waveguide comprising at least one output grating with an optical prescription providing angularly varying optical power for focusing said field of view onto an external surface.

2. The waveguide display of claim 1, wherein said at least one output grating includes at least one grating prescription providing at least two different focal lengths across said FOV.

3. The waveguide display of claim 1, wherein said at least one output grating includes at least one grating prescription providing a first focal length for focusing a first FOV portion onto a first area of said surface and a second focal length for focusing a second FOV portion onto a second area of said surface.

4. The waveguide display of claim 1, wherein said at least one output grating includes at least one grating prescription providing a continuously varying focal length across at least a portion of said FOV.

5. The waveguide display of claim 1, wherein said external surface subtends an angle of less than 45 degrees to a viewing axis of said display.

6. The waveguide display of claim 1, wherein said external surface subtends and angle of less than 15 degrees to viewing axis of said display.

7. The waveguide display of claim 1, further comprising a reflective or transmissive optical-powered element disposed along an optical path from said waveguide and a viewer of said waveguide display.

8. The waveguide display of claim 1, wherein said source of image modulated light provides first image data for projection at a first range and second image data for projection at a second range.

9. The waveguide display of claim 8 wherein said first and second image data are digitally magnified to provide projected image dimensions on said external surface scaled to said first and second ranges.

10. The waveguide display of claim 1, wherein said at least one output grating includes at least one grating prescription providing a first focal length for focusing a first FOV portion onto a first area of said surface located at less than 3 meters from said waveguide and a second focal length for focusing a second FOV portion onto a second area of said surface located at greater than 3 meters from said waveguide.

11. The waveguide display of claim 1, wherein said at least one output grating includes at least one grating switchable between a diffracting state and a non-diffracting state.

12. The waveguide display of claim 1, wherein said external surface comprises a surface selected from the group consisting of: a virtual image surface, a real image surface, a curved surface, a reflective surface, and an at least partially transmissive surface.

13. The waveguide display of claim 1, wherein said source of image modulated light comprises an optical engine selected from the group consisting of: a scanned laser projector, a projector comprising an emissive display and a collimator, a projector comprising a microdisplay illuminated by one of laser or LED and a collimator, and a structured light projector.

14. The waveguide display of claim 1, wherein said waveguide provides a projector in a windscreen reflection head up display, wherein said at least one output grating includes at least one grating prescription for correcting distortions introduced by reflection at said windscreen.

15. The waveguide display of claim 1, wherein said at least one output grating includes at least one grating prescription for correction of a characteristic selected from the group consisting of: distortion introduced by an optical element disposed between waveguide and a viewer, polarization non-uniformity, and illumination non-uniformity.

16. The waveguide display of claim 1, wherein said at least one output grating includes at least one grating prescription for diffracting radiation in the infrared band.

17. The waveguide display of claim 1, wherein imaging by said waveguide operates according to the Scheimpflug principle.

18. The waveguide display of claim 1, further comprising at least one of a LIDAR, an eye tracker, a lens with electrically variable optical power, or a despeckler.

19. A method of viewing an image, comprising the steps of:
providing a source of image modulated light projected over a field of view;
providing a waveguide comprising at least one output grating with an optical prescription for focusing said field of view onto an external surface;
tilting the output optical axis of said waveguide at an acute angle to said surface;
focusing a first FOV portion onto a first area of said surface; and
focusing a second FOV portion onto a second area of said surface.

20. A method of viewing an image, comprising the steps of:
providing a source of image modulated light projected over a field of view;
providing a waveguide supporting a switchable output grating with a prescription providing at least two different focal lengths across said FOV;
providing a waveguide supporting a switchable output grating with a prescription providing continuously varying focal length across at least a portion of said FOV;
tilting the output optical axis of said waveguide at an acute angle to said surface;
switching said first grating into a diffracting state and switching said second grating into a non-diffracting state;
focusing a first FOV portion onto a first area of said surface;
focusing a second FOV portion onto a second area of said surface;
switching said first grating into a non-diffracting state and switching said second grating into a diffracting state; and
providing a continuously varying focal length across at least a portion of said FOV.
